(19) United States
(12) Patent Application Publication
(10) Pub. No.: US 2010/0242499 A1
(43) Pub. Date: Sep. 30, 2010

(54) METHOD FOR RE-GASIFICATION OF LIQUID NATURAL GAS

(76) Inventors: Jose Lourenco, Edmonton (CA); MacKenzie Millar, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/303,956

(22) PCT Filed: Jun. 6, 2007
(86) PCT No.: PCT/CA07/00984

§ 371 Date: Dec. 8, 2008

(30) Foreign Application Priority Data
Jun. 8, 2006 (CA) 2551062

(51) Int. Cl. F17C 9/02

(52) U.S. Cl. 62/50.2

(57) ABSTRACT

A method for re-gasification of liquid natural gas involves positioning a storage vessel (22) for liquid natural gas at a facility (12) that has at least one refrigeration unit (48) with circulating fluid heat transfer medium. A second step involves providing at least one heat exchanger (24). A heat exchange takes place during circulation through the heat exchanger between the liquid natural gas and the circulating fluid heat transfer medium which raises the temperature of the liquid natural gas changing it from a liquid phase to a gaseous phase in preparation for consumption and which lowers the temperature of the circulating fluid heat transfer medium in preparation for use in the at least one refrigeration unit (48).

### FIELD OF THE INVENTION

The present invention relates to a method for re-gasification of liquid natural gas.

### BACKGROUND OF THE INVENTION

Conventional Liquid Natural gas (LNG) re-gasification processes require an external heat source. Heat is usually provided by using various types of vaporizers; such as seawater vaporizers, submerged combustion vaporizers, intermediate fluid vaporizers or ambient air vaporizers. LNG vaporization is an energy intensive process. Seawater heating is the most common method of re-gasification at LNG seaport terminals. New LNG re-gasification processes integrate the vaporization process with a power plant to maximize overall power efficiency. This practice is limited at centralized LNG terminals

### SUMMARY OF THE INVENTION

According to the present invention there is provided a method for re-gasification of liquid natural gas. A first step involves positioning a storage vessel for liquid natural gas at a facility that has at least one refrigeration unit that uses a circulating fluid heat transfer medium for cooling purposes on an on going basis. A second step involves providing at least one heat exchanger that has a primary fluid flow path for passage of liquid natural gas from the storage vessel and at least one secondary fluid flow path for passage of the circulating fluid heat transfer medium to the refrigeration unit. A third step involves circulating liquid natural gas along the primary fluid flow path and the circulating fluid heat transfer medium along the at least one secondary fluid flow path. A heat exchange takes place during circulation through the heat exchanger between the liquid natural gas and the circulating fluid heat transfer medium which raises the temperature of the liquid natural gas changing it from a liquid phase to a gaseous phase in preparation for consumption and which lowers the temperature of the circulating fluid heat transfer medium in preparation for use in the at least one refrigeration unit.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a schematic diagram of a facility equipped with liquid natural gas re-gasification in accordance with the teachings of the present invention.

FIG. 2 is an enlarged schematic diagram of the liquid natural gas re-gasification portion of FIG. 1.

FIG. 3 is a variation of the cold box schematic diagram of the natural gas re-gasification portion of FIG. 2.

FIG. 4 is a variation of the applications for cold energy as FIG. 1.

FIG. 5 is another variation of applications for cold energy as FIG. 1.

FIG. 6 is yet another variation for cold energy applications as FIG. 1.

### DETAILED DESCRIPTION OF THE PREFERRED EMBODIMENT

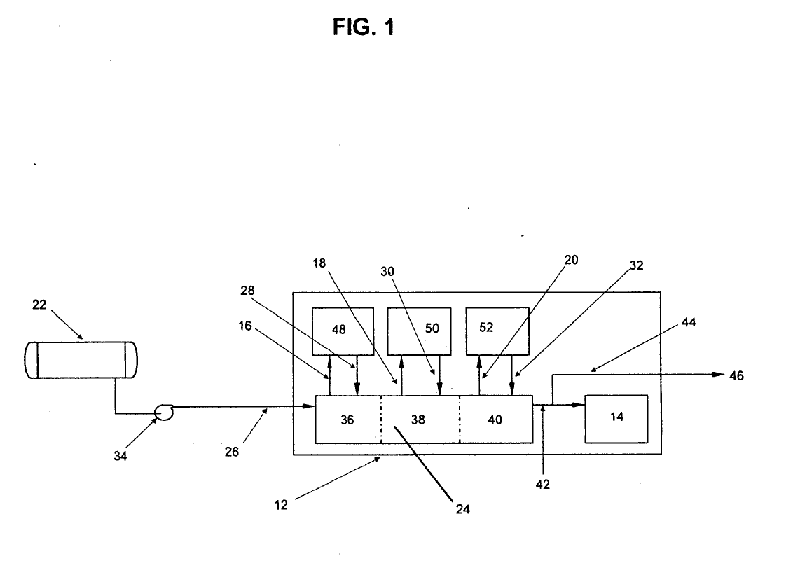

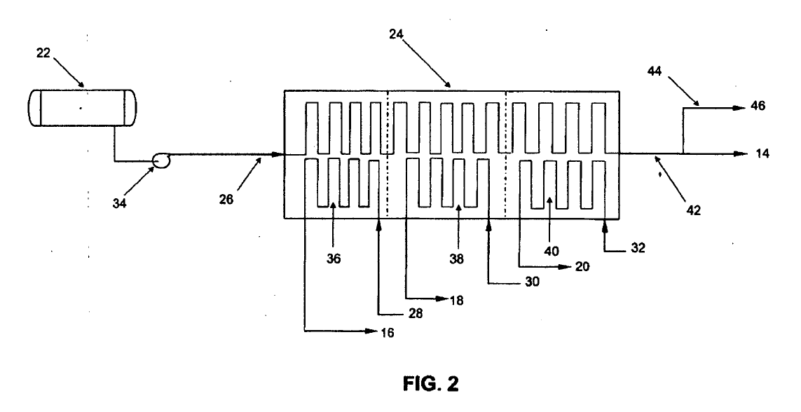

The preferred method will now be described with reference to FIG. 1 and FIG. 2.

Referring to FIG. 1, there is illustrated a facility generally indicated by reference numeral 12. Facility 12 has a fuel burner 14 that uses natural gas as a fuel source on an on going basis and a gas line 44 to supply excess gas to gas main distribution network 46. Facility 12 also has at least one refrigeration unit that uses a circulating fluid heat transfer medium for cooling purposes on an on going basis. For the purpose of illustration, facility 12 is shown to have a cryogenic unit 48, a freezer unit 50, and a cooler unit 52. A storage vessel 22 is provided for storage of liquid natural gas on site at facility 12. At least one heat exchanger is provided between storage vessel 22 fuel burner 14 and gas to gas line 44 leading to gas main distribution network 46.

Referring to FIG. 2, for the purpose of illustration a cold box 24 has been selected. Cold box 24 has a primary fluid flow path 26 for passage of liquid natural gas from storage vessel 22 to fuel burner 14 and or to gas to gas line 44 leading to gas main distribution network 46. Cold box 24 also has more than one secondary fluid flow path for passage of the circulating fluid heat transfer medium. For the purpose of illustration, cold box 24 is shown as having secondary flow path 28 supplying circulating fluid heat transfer medium to cryogenic section 36 and exiting the unit via stream 16, secondary flow path 30 supplying circulating fluid heat transfer medium to freezer section 38 and exiting the unit via stream 18, and secondary flow path 32 supplying circulating fluid heat transfer medium to cooler section 40 and exiting the unit via stream 20.

Liquid Natural Gas (LNG) is stored at −160 C at atmospheric pressure in storage vessel 22, which is an insulated cryogenic tank. Typically the LNG is re-gasified at the receiving seaport terminal before being distributed into the pipeline networks. The proposed process stores LNG at the point of use with the intention of using the cold that users require for refrigeration in their production facilities. The objective being to control and match the usage patterns of LNG with cryogenic energy patterns. LNG is pumped by pump 34 to a set pressure into cold box 24. The cold box has three sections; a cryogenic section 36 in which secondary flow path 28 is positioned, a freezer section 38 in which secondary flow path 30 is positioned and a cooler section 40 in which secondary flow path 32 is positioned. A heat exchange takes place during circulation through cold box 24 between the liquid natural gas and the circulating fluid heat transfer medium. As will hereinafter be further explained, this raises the temperature of the liquid natural gas changing it from a liquid phase to a gaseous phase in preparation for consumption in the fuel burner and lowers the temperature of the circulating fluid heat transfer medium in preparation for use in the various refrigeration units. The LNG first enters cryogenic section 36 where it exchanges its extreme cold for cryogenic uses. A two phase flow then enters freezer section 38 where additional cold is given up for freezer applications. Now a vapor, it enters the cooler section 40 where low level cold is given up before it exits cold box 24 as a re-gasified natural gas stream ready for use. The coolant stream for each section is selected based on their properties for the field of use. The temperature control in each stream is controlled by the circulation flow rate.

LNG possesses two types of energy; hydrocarbon fuel and “cold energy”. The above described method recovers this stored “cold energy” by integrating the use of LNG with fuel and main gas distribution networks requirements and with required refrigeration requirements in residential, commercial and industrial applications

The typical heating curve of LNG shows a potential in power savings of 250 KWh/ton of LNG.

The field of application is vast, varying from the high density residence complexes, beverages, food, meat processing and poultry processing to the refinery/petrochemical industries.
A dairy processing plant needs to burn fuel to operate its homogenization and processing equipment. The dairy processing plant also has refrigeration needs as, after processing, the milk needs to be refrigerated and products such as ice cream must be kept frozen.
A poultry processing plant needs to burn fuel to operate its processing equipment. The poultry processing plant also has refrigeration needs as, after processing, the poultry products must be kept in a freezer or cooler.
A recreational facility needs to burn fuel to heat the facilities and swimming pools. The recreational facility may also have an ice rink that requires on going refrigeration input.

### Variations:

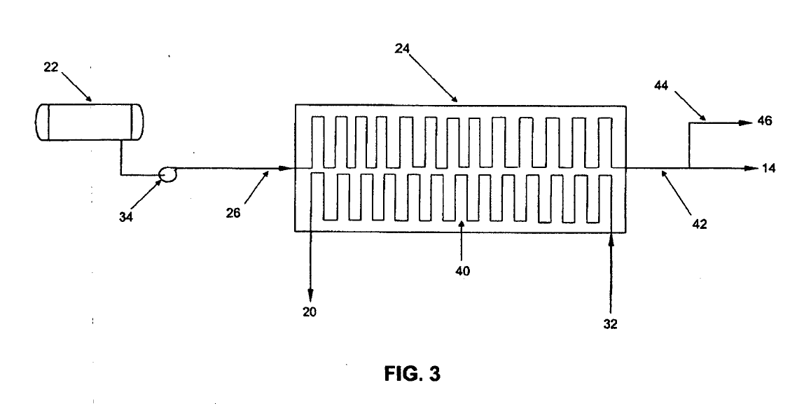

FIG. 3 through 6 have been provided to show variations which use the same teaching. In FIG. 3 through 6, the reference numerals identify identical components as have been previously described in FIG. 1 and FIG. 2. These variations recognize that the needs of the facility may vary depending upon the type of facility, the season and the cooperation one may obtain from companies controlling natural gas distribution networks providing gaseous phase natural gas to other consumers.

FIG. 3 recognizes a situation in which the facility has substantial cooling needs, but is unable to consume all of the gaseous phase natural gas that is produced. In such a case, the excess gas is diverted by gas line 44 to main gas distribution network 46. As previously mentioned, this would require cooperation from the company owning and controlling main gas distribution network 46. FIG. 3 also recognizes that the cold box or heat exchanger used need not be divided into three sections, but may come in different configurations. The configuration shown for illustration has a single cooler section, cryogenic section 36 and freezer section 38 having been eliminated.

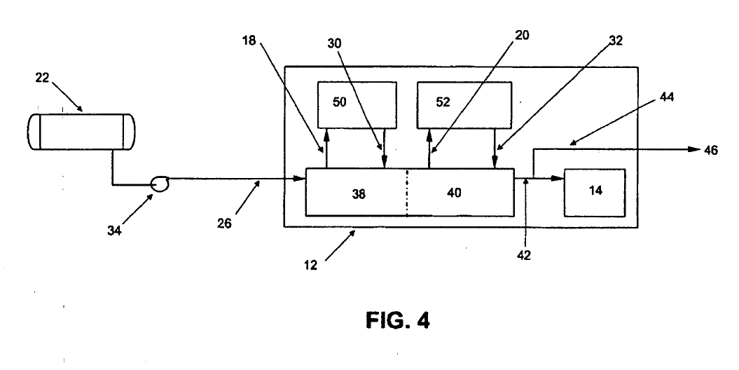

FIG. 4 shows an installation in which only a freezer section 38 for freezer unit 50 and cooler section 40 for cooler unit 52 have been provided. A portion of the gaseous phase natural gas is consumed in fuel burner 14 related to the operation of the facility and the balance is diverted by gas line 44 to main gas distribution network 46.

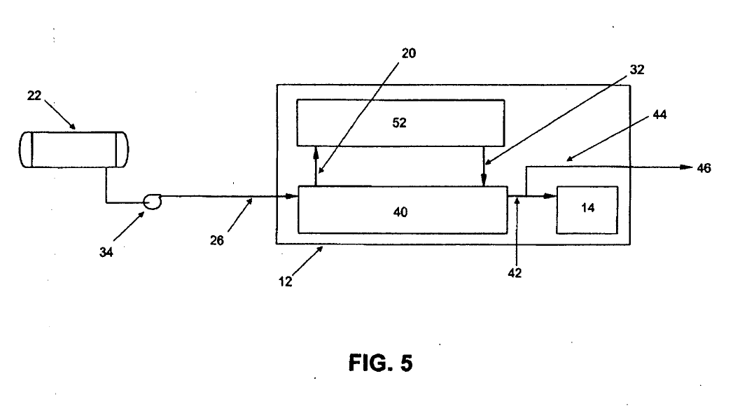

FIG. 5 shows an installation in which only a cooler section 40 for cooler unit 52 have been provided. A portion of the gaseous phase natural gas is consumed in fuel burner 14 related to the operation of the facility and the balance is diverted by gas line 44 to main gas distribution network 46.

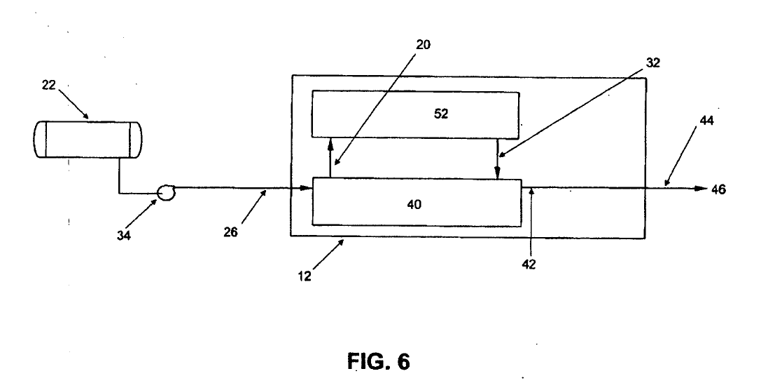

FIG. 6 shows an installation in which the facility has no need of the gaseous phase natural gas produced and all of the gaseous phase natural gas produced is diverted by gas line 44 to main gas distribution network 46.

The needs of a facility may change with seasonal variations. For example, if the gaseous phase natural gas was consumed solely for heating purposes, it may all be consumed during cold winter months, not be needed at all during warm summer months and only partially be consumed during the moderate months of spring and fall.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

What is claimed is:

1. A method for re-gasification of liquid natural gas, comprising the steps of:
positioning a storage vessel (22) for liquid natural gas at a facility (12) that has at least one refrigeration unit (48) that uses a circulating fluid heat transfer medium for cooling purposes on an on going basis;
providing at least one heat exchanger (24) having a primary fluid flow path (26) for passage of liquid natural gas from the storage vessel (22) and at least one secondary fluid flow path (28) for passage of the circulating fluid heat transfer medium to the at least one refrigeration unit (48);
circulating liquid natural gas along the primary fluid flow path (26) and the circulating fluid heat transfer medium along the at least one secondary fluid flow path (28), a heat exchange taking place during circulation through the heat exchanger (24) between the liquid natural gas and the circulating fluid heat transfer medium which raises the temperature of the liquid natural gas changing it from a liquid phase to a gaseous phase in preparation for consumption and which lowers the temperature of the circulating fluid heat transfer medium in preparation for use in the at least one refrigeration unit (48).

2. The method as defined in claim 1, wherein the at least one heat exchanger (24) is a cold box (24) having more than one secondary fluid flow path (28, 30, 32).

3. The method as defined in claim 1, wherein at least some of the gaseous phase natural gas is consumed by a fuel burner (14) at the facility (12).

4. The method as defined in claim 3, wherein excess gaseous phase natural gas is diverted to a main natural gas distribution line (44) providing natural gas to other natural gas consumers (46).

5. The method as defined in claim 1, wherein the gaseous phase natural gas is diverted to a main natural gas distribution line (44) providing natural gas to other natural gas consumers (46).

6. In combination:
a facility (12) that has at least one refrigeration unit (48) that uses a circulating fluid heat transfer medium for cooling purposes on an on going basis;
a storage vessel (22) for liquid natural gas on site at the facility (12);
at least one heat exchanger (24), the at least one heat exchanger (24) having a primary fluid flow path (26) for passage of liquid natural gas from the storage vessel (22) and at least one secondary fluid flow path (28) for passage of the circulating fluid heat transfer medium to the at least one refrigeration unit (48), whereby a heat exchange takes place during circulation through the heat exchanger between the liquid natural gas and the circulating fluid heat transfer medium which raises the temperature of the liquid natural gas changing it from a liquid phase to a gaseous phase in preparation for consumption and which lowers the temperature of the circulating fluid heat transfer medium in preparation for use in the at least one refrigeration unit (48).

7. The combination as defined in claim 6, wherein the at least one heat exchanger (24) is a cold box (24) having more than one secondary fluid flow path (28, 30, 32).
